(19) United States
(12) Patent Application Publication
(10) Pub. No.: US 2010/0156811 A1
(43) Pub. Date: Jun. 24, 2010

(54) NEW PATTERN DESIGN FOR A CAPACITIVE TOUCH SCREEN

(76) Inventors: Ding Hua Long, Shenzhen (CN); Hai Long Zhang, Shenzhen (CN); Hong Xin Mo, Shenzhen (CN)

Correspondence Address: MARSH, FISCHMANN & BREYFOGLE LLP, 8055 East Tufts Avenue, Suite 450, Denver, CO, 80237, US

(21) Appl. No.: 12/341,392

(22) Filed: Dec. 22, 2008

(51) Int. Cl. G06F 3/041

(52) U.S. Cl. 345/173

(57) ABSTRACT

A capacitive touch sensor assembly that includes multiple regions is provided herein. Each of the multiple regions may include a top and a bottom array of patterned conductive material, such as indium tin oxide. The touch sensor assembly may further include a separate controller for each region, wherein the patterned conductive material in each region is coupled to the controller associated with that region. In one configuration, the top array of each region may not be aligned with the associated bottom region, such that multiple controllers may sense touches at a single point. Further, the patterned conductive material may include a plurality of rows and columns of diamond-shaped electrodes, wherein all of the electrodes have substantially the same surface area.

### BACKGROUND

As computers and other electronic devices become more popular, touch-sensing systems are becoming more prevalent as a means for inputting data. For example, touch-sensing systems can be found in automatic teller machines, personal digital assistants, casino game machines, mobile phones, and numerous other applications.

Capacitive touch sensing is one of the most widely used techniques in touch screen industries. Capacitive touch sensors are mainly divided in two groups, namely, continuous capacitive sensors and discontinuous (patterned) capacitive sensors. In a continuous capacitive sensor, the sensor includes a sheet of conducting thin film that is electrically excited from four corners of the touch screen. The signals induced by a user's touch are transmitted from the corners to a controller, where they are decoded and translated into coordinates. In a typical patterned capacitive touch screen, the sensor may include one or more series of parallel conductive bars that are driven from one or both ends with an excitation signal from a controller. The signals induced by a user's touch may be transmitted to the controller with the same lead lines that excite the sensor bars. These signals may then be decoded in the controller and the touch coordinates may be reported to a computer.

Touch sensors utilizing more than one patterned sensing layer are often used to determine the coordinates of a touch with high accuracy, provided that the sensing layers have a suitable pattern geometry. One example of a touch screen assembly 10 that includes two patterned conductive layers 12 and 14 is shown in FIG. 1A and FIG. 1B. The patterned conductive layers 12 and 14 may be made from a transparent conductive material, such as indium tin oxide (ITO), and each layer is generally disposed on a transparent substrate (not shown). Each row of conducting elements of each of the sensor layers 12 and 14 includes a series of diamond-shaped electrodes that are connected to each other with short strips of relatively narrow rectangles. A dielectric layer 16 separates the two conductive layers 12 and 14, and serves to prevent them from coming into direct contact with each other. As an example the dielectric layer 16 may include an adhesive manufactured from any non-conductive, transparent material.

As shown, the end of each row of the two patterned conductive layers 12 and 14 is coupled to one of a set of lead lines 18 that are in turn coupled to a controller 20. The controller 20 may include circuitry for providing excitation currents to the capacitive sensors 12 and 14 and for detecting signals generated by the sensors. Further, the controller 20 may include logic for processing the signals and conveying touch information to another part of an electronic device, such as a processor.

As discussed above, one type of material used for the patterned conductive layers is ITO, which has a relatively high resistivity, which limits the length of the rows and columns of electrodes that may be used. As can be appreciated, this imposes a limit on the size of the overall touch screen, which may be undesirable for applications where a larger display and touch screen would be beneficial.

It is against this background that the new pattern designs for capacitive touch screens described herein have been invented.

### SUMMARY

The following embodiments and aspects of thereof are described and illustrated in conjunction with systems, tools, and methods which are meant to be exemplary and illustrative, and not limiting in scope. In various embodiments, one or more of the above-described problems have been reduced or eliminated, while other embodiments are directed to other improvements.

According to a first aspect, a touch panel assembly is provided that includes a top conductive film that is patterned to form at least two top arrays that each include a plurality of sets of electrodes. The electrodes in each set of electrodes are coupled together by the top conductive film, and each set of electrodes has a first end and a second end, the first end being positioned near an edge of touch panel assembly and the second end being positioned away from the edge. The second end of each set of electrodes in each top array is disposed adjacent to the second end of a set of electrodes from a different top array. The touch panel assembly also includes a bottom conductive film that is patterned to form at least two bottom arrays that each include a plurality of sets of electrodes. The electrodes in each set of electrodes are coupled together by the bottom conductive film, and wherein each set of electrodes has a first end and a second end, the first end being positioned near an edge of the touch panel assembly and the second end being positioned away from the edge. The second end of each set of electrodes in each bottom array is disposed adjacent to the second end of a set of electrodes from a different bottom array. The touch panel assembly further includes an insulating layer disposed between the top conductive film and the bottom conductive film. Additionally, the electrodes at the second end of each of the sets of electrodes have substantially the same area as the electrodes that are adjacent to the electrodes at the second end of each of the sets.

According to a second aspect, an electronic device is provided that includes a display and a touch panel assembly overlaying the display. The touch panel assembly includes a top transparent substrate that is coated with a top conductive film on its lower surface. The top conductive film is patterned to form at least two top arrays that each include a plurality of sets of electrodes, wherein the electrodes in each set of electrodes are coupled together by the top conductive film, and wherein each set of electrodes has a first end and a second end. The first end is positioned near an edge of the top transparent substrate and the second end is positioned away from the edge, and the second end of each set of electrodes in each top array is disposed adjacent to the second end of a set of electrodes from a different top array.

The touch panel assembly also includes a bottom transparent substrate that is coated with a bottom conductive film on its upper surface. The bottom conductive film is patterned to form at least two bottom arrays that each include a plurality of sets of electrodes, wherein the electrodes in each set of electrodes are coupled together by the bottom conductive film, and wherein each set of electrodes has a first end and a second end. The first end is positioned near an edge of the bottom transparent substrate and the second end being positioned away from the edge, and the second end of each set of electrodes in each bottom array is disposed adjacent to the second end of a set of electrodes from a different bottom array. The touch panel assembly also includes an insulating layer disposed between the top transparent substrate and the bottom transparent substrate. Further, the electrodes at the second end of each of the sets of electrodes have substantially the same area as the electrodes that are adjacent to the electrodes at the second end of each of the sets. The electronic device also includes at least one controller that is coupled to the first end of each set of electrodes, the at least one controller being operable to provide electrical signals to the electrodes. According to a third aspect, a touch panel assembly is provided that includes a top transparent substrate that includes a patterned top conductive layer. The top patterned conductive layer includes a first set of electrodes that are electrically stimulated by a first controller and a second set of electrodes that are electrically stimulated by a second controller. A first boundary is formed between the first set of electrodes and the second set of electrodes, and the electrodes adjacent to the first boundary are substantially diamond-shaped. The touch panel assembly also includes a bottom transparent substrate that includes a patterned bottom conductive layer. The bottom patterned conductive layer includes a third set of electrodes that are electrically stimulated by the first controller and a fourth set of electrodes that are electrically stimulated by the second controller. A second boundary is formed between the third set of electrodes and the fourth set of electrodes, and the electrodes adjacent to the second boundary are substantially diamond-shaped. The touch panel assembly further includes an insulating layer disposed between the top transparent substrate and the bottom transparent substrate. Additionally, at least portions of the first boundary and the second boundary are not aligned with each other.

According to a fourth aspect, a touch panel assembly is provided that includes a first patterned conductive layer including a plurality of regions that each include one or more substantially parallel elongated electrodes. The one or more elongated electrodes in one or more regions have a greater length than the one or more elongated electrodes in one or more other regions, the boundaries between the regions being defined by boundary lines, wherein the boundary lines in the layer are either substantially parallel to or substantially orthogonal to each other, wherein for at least one of two orthogonal directions across the layer the boundary lines are parallel but not collinear. The touch panel assembly also includes a second patterned conductive layer including a plurality of regions that each include one or more substantially parallel elongated electrodes. The one or more elongated electrodes in one or more regions have a greater length than the one or more elongated electrodes in one or more other regions, the boundaries between the regions being defined by boundary lines, wherein the boundary lines in the layer are either substantially parallel to or substantially orthogonal to each other, wherein for at least one of two orthogonal directions across the layer the boundary lines are parallel but not collinear. The touch panel assembly further includes an insulating layer disposed between the first and second patterned conductive layers. Additionally, there are non-collinear boundary lines in one of the first and second patterned conductive layers that are substantially orthogonal to and in a separate substantially parallel plane from non-collinear boundary lines in the other of the first and second patterned conductive layers.

In addition to the exemplary aspects and embodiments described above, further aspects and embodiments will become apparent by reference to the drawings and by study of the following descriptions.

### BRIEF DESCRIPTION OF THE DRAWINGS

FIGS. 1A and 1B illustrate a top view and cross-sectional view of a prior art capacitive touch sensor assembly.

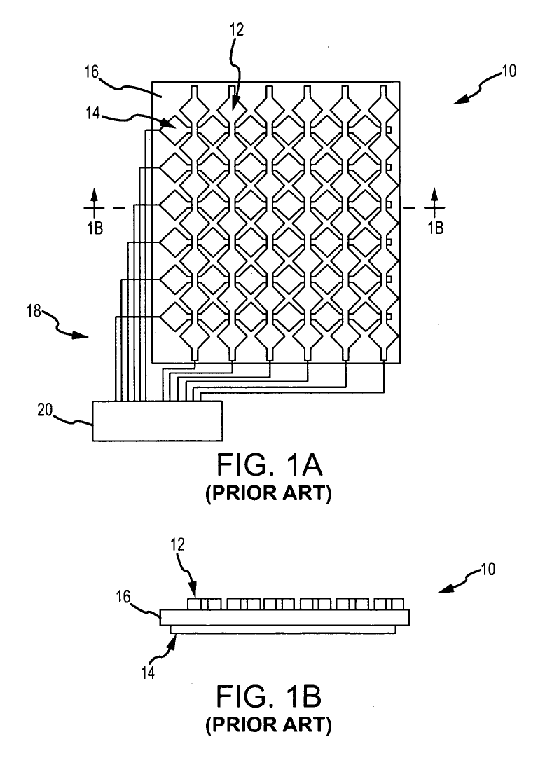

FIG. 2 illustrates an automatic teller machine that incorporates an exemplary touch screen assembly.

FIG. 3 illustrates an electronic device that incorporates an exemplary touch screen sensor assembly.

FIG. 4 illustrates the configuration of various layers for an exemplary touch screen sensor assembly.

FIG. 5 illustrates a bottom layer of transparent conductive material for an exemplary touch screen sensor assembly.

FIG. 6 illustrates a top layer of transparent conductive material for an exemplary touch screen sensor assembly.

FIG. 7 illustrates the top and bottom layers of conductive material for an exemplary touch screen sensor assembly.

FIG. 8 illustrates a bottom layer of transparent conductive material for an exemplary touch screen sensor assembly.

FIG. 9 illustrates a top layer of transparent conductive material for an exemplary touch screen sensor assembly.

FIG. 10 illustrates the top and bottom layers of conductive material for an exemplary touch screen sensor assembly.

### DETAILED DESCRIPTION

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope and spirit of the invention as defined by the claims.

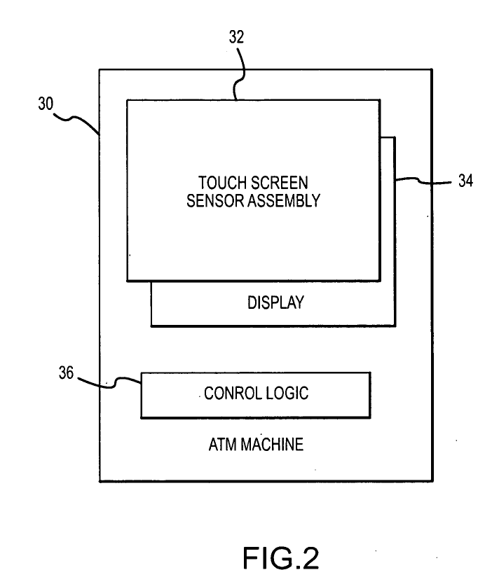

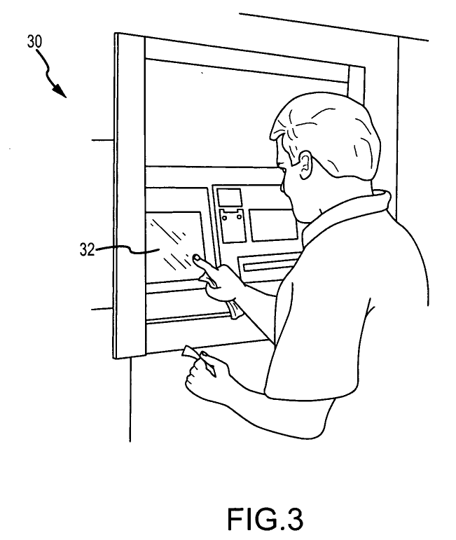

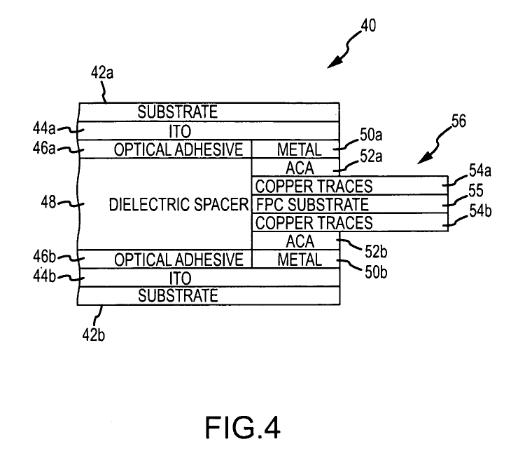

FIGS. 2 and 3 illustrate an automatic teller machine (ATM) 30 that incorporates an exemplary touch screen sensor assembly 32. Although the ATM 30 is illustrated, the embodiments described herein may be incorporated into any electronic device that incorporates a touch screen, such as a personal digital assistant (PDA), a casino game machine, a mobile phone, a computer, a voting machine, or any other electronic device. The touch screen sensor assembly 32 may include two layers of transparent patterned conductive material, such as ITO, that are disposed on two substrates positioned in a spaced, parallel relationship (see FIG. 4). The touch screen sensor assembly 32 may also be coupled to control logic 36 (shown in FIG. 2) that is operable to excite the conductive material and to sense touches on or near the touch screen sensor assembly 32. As an example, the control logic 36 may include a commercial touch screen controller (e.g., a controller provided by Cypress Semiconductor, Analog Devices, Atmel, Synaptics, and others), an application specific integrated circuit (ASIC), or any other suitable controller. Further, the touch sensor assembly 32 may overlay a display 34 (shown in FIG. 2), which may be any type of display, such as an LCD display.

FIG. 4 illustrates the various layers that may be included in an exemplary touch screen sensor assembly 40. The assembly 40 includes a top substrate 42a and a bottom substrate 42b that are each coated with patterned ITO layers 44a and 44b, respectively, that include a plurality of electrodes. The substrates 42a and 42b may be configured from any suitable transparent material, including glass, plastic, or the like. Further, the top ITO layer 44a may be separated from the bottom ITO layer 44b by a suitable dielectric spacer 48 that is adhered by optically clear adhesive layers 46a and 46b.

As discussed above, the ITO layers 44a and 44b may be coupled to one or more controllers that are operable to excite and sense electrical signals on the electrodes of the ITO layers 44a and 44b. To electrically connect the controller to the ITO layers 44a and 44b, a flexible printed circuit (FPC) 56 may be coupled to the assembly 40. The FPC 56 may include an FPC substrate 55, top copper traces 54a, and bottom copper traces 54b that are used to couple the top and bottom ITO layers 44a and 44b to a controller. To make the connection between the copper traces 54a and 54b and the ITO layers 44a and 44b, metal portions 50a and 50b may be disposed in contact with portions of the ITO layers. Further, the metal portions 50a and 50b may be coupled to the copper traces 54a and 54b using electrically conducive adhesive layers 52a and 52b, which may, for example, include an anisotropic conductive adhesive (ACA).

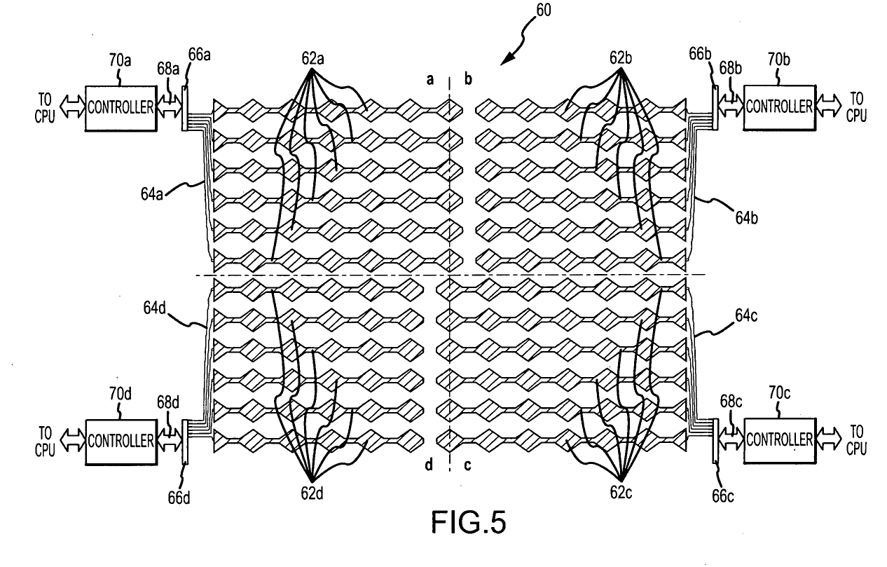

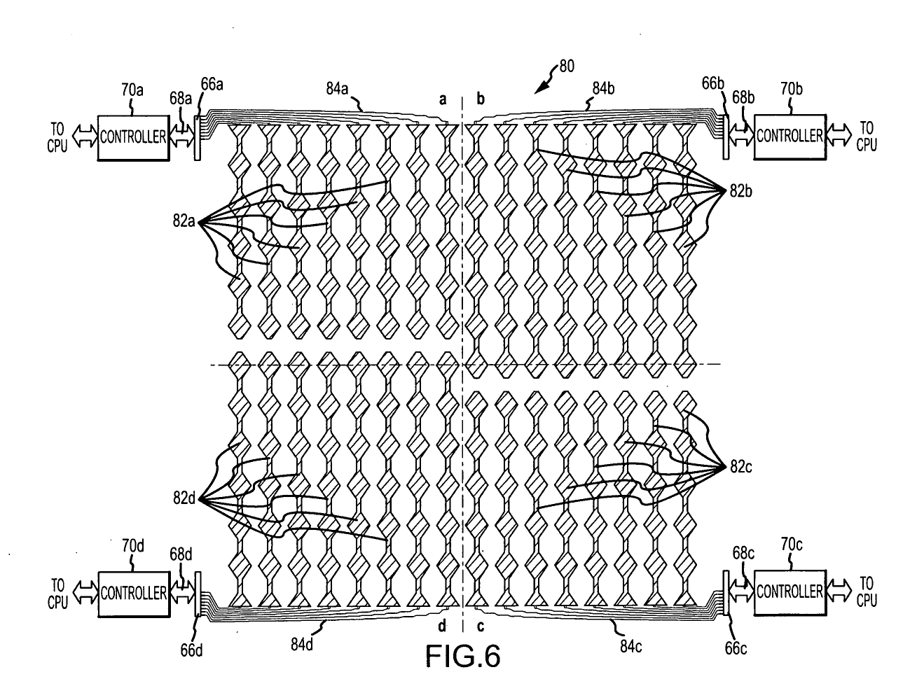

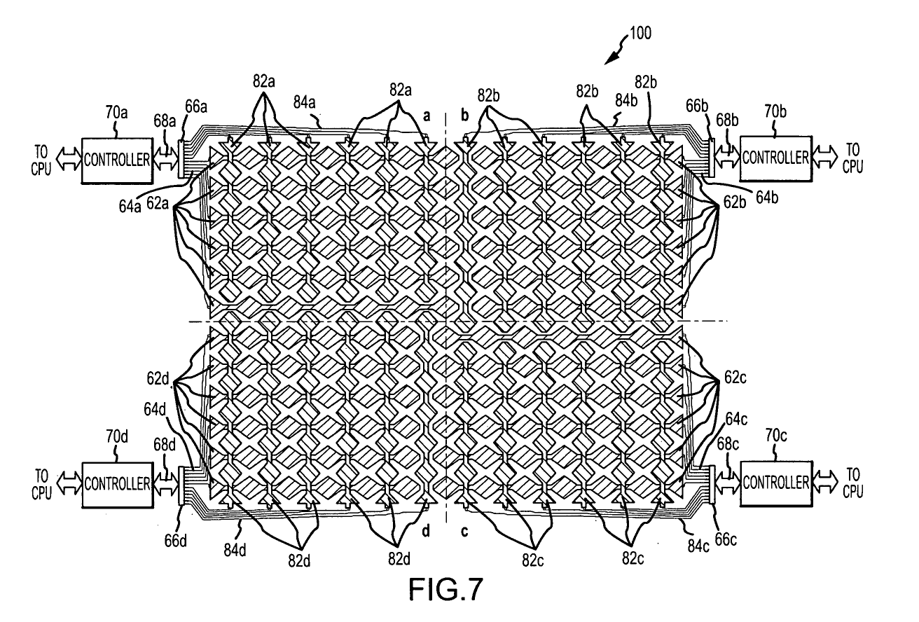

FIGS. 5-7 illustrate a bottom conductive layer 60 (shown in FIG. 5), a top conductive layer 80 (shown in FIG. 6), and the combined assembly 100 of the top and bottom layers (FIG. 7) for an exemplary touch sensor assembly. For illustration purposes, only the transparent conductive material (e.g., ITO) layers 60 and 80 are shown, but it should be appreciated that other layers may be present in the touch sensor assembly (e.g., substrates, adhesives, light filters, or the like).

FIG. 5 illustrates the bottom layer 60 of patterned conductive material that may be included in a capacitive touch sensor assembly, such as the touch sensor assembly 40 shown in FIG. 4. For reasons described below, the touch screen assembly 100 is divided into four quadrants a, b, c, and d, as indicated by the vertical and horizontal dashed lines. Each quadrant a-d includes an array of rows 62a-d of diamond-shaped electrodes that are coupled together by relatively thin strips of the conductive material.

To excite and sense electrical signals in the electrodes, the rows 62a-d are each coupled to a corresponding controller 70a-d. In this embodiment, metal traces 64a-d are provided to couple the rows 62a-d to connectors 66a-d, which are in turn coupled to the controllers 70a-d through electrical couplings 68a-d (e.g., an FPC). It should be appreciated that the electrodes in the rows 62a-d may be coupled to the controllers 70a-d in any suitable manner.

The bottom layer 60 is divided into four quadrants a, b, c, and d, so that the number of diamond-shaped electrodes in each of the rows 62a-d may be limited. As can be appreciated, the electrical resistance of each of the rows 62a-d is directly related their length. In larger touch screens (e.g., greater than 5 inches, greater than 10 inches, or the like), it may be desirable to limit the length (and therefore the resistance) of each row of electrodes, which may improve the touch sensing performance of the touch sensor assembly. For example, when a controller induces electrical signals in the electrodes, the time required to induce a voltage is related to the resistance and capacitance (RC) of the electrodes, so a lower resistance permits faster response times for sensing touches. Of course, another way to reduce the resistance of the electrodes would be to make them wider or to use a lower resistivity conductive layer, but both of these methods present additional problems. For instance, wider electrodes may increase the parasitic capacitance, which will reduce the response time of the electrodes, while using a low resistivity conductive layer may undesirably increase the visibility of the conductive layer, thereby impeding the transmission of the underlying display.

In order to provide improved touch sensitivity, it may also be desirable that the electrodes have a surface area that is relatively large, because larger electrodes are more sensitive to a users touch. However, there is a practical limit to the surface area of the individual electrodes, because as the surface area increases, the resolution of the touch sensor assembly decreases due to the fewer number of electrodes used in the touch sensor As shown, the rows 62a and 62c include one more electrode than the rows 62b and 62d, such that the electrodes at the end of the rows 62a and 62c are positioned along the dashed vertical line that divides the bottom layer 60 into left and right halves. That is, the vertical boundary line between the rows 62a and 62b is in quadrant b, and the boundary line between the rows 62c and 62d is in quadrant d. As described below in relation to FIG. 7, this configuration allows the electrodes at the end of the rows 62a-d to be full size (i.e., to have substantially the same surface area as the other electrodes). Further, this configuration allows touches near the edges of the four quadrants a, b, c, and d, to be sensed using more than one of the controllers 70a-d, which may improve the touch sensing performance of the touch sensor assembly by reducing discontinuities.

FIG. 6 illustrates the top layer 80 of conductive material (e.g., ITO) for a touch sensory assembly. The top layer 80 is similar to the bottom layer 60 shown in FIG. 5 in most respects, except that the strips of conductive material are patterned into four arrays of columns 82a-d that are positioned in the four quadrants a, b, c, d. As shown, the columns 82b and 82d include one more electrode than the columns 82a and 82c, such that the electrodes at the ends of the columns 82b and 82d are bisected by the horizontal dashed line that separates the top half of the touch sensor assembly from the bottom half.

Similar to the rows 62a-d, the columns 82a-d are each coupled to one of the corresponding controllers 70a-d. Further, metal traces 84a-d are provided to couple the columns 82a-d to connectors 66a-d, which are in turn coupled to the controllers 70a-d through electrical couplings 68a-d (e.g., an FPC). It should be appreciated that the electrodes in the columns 82a-d may be coupled to the controllers 70a-d in any suitable manner.

FIG. 7 illustrates an assembled touch sensor assembly 100 that includes the bottom layer 60 (shown in FIG. 5) and the top layer 80 (shown in FIG. 6) in an assembled configuration. As shown, the columns 82a-d are positioned over the rows 62a-d to form an “interwoven” pattern (not actually interwoven as each layer lies in a separate, substantially parallel plane). Although not shown here, it should be appreciated that the top layer 80 is electrically isolated from the bottom layer 60 by a dielectric spacer, such as the dielectric spacer 48 shown in FIG. 4. In operation, the four controllers 70a-d may excite and sense electrical signals on the electrodes of the rows 62a-d and columns 82a-d of conductive material. When a user's finger or a stylus comes near the touch sensor assembly 100, changes in the capacitance of the electrodes are sensed by one or more of the controllers 70a-d.

When a user touches the touch sensor assembly 100 in one of the four quadrants a, b, c, or d, the respective controller 70a, 70b, 70c, or 70d will sense the touch because the electrodes that are proximate to the touch are coupled to the specific controller for that quadrant. However, if a user touches the touch sensor assembly 100 near one of the boundaries formed between electrodes coupled to different controllers, multiple controllers 70a-d may sense the single touch since the electrodes from multiple controllers overlap each other at the boundary lines. For example, if a user places his finger near the dashed line between the quadrants b and c, then both of the controllers 70b and 70c may sense the user's touch.

This configuration may offer several advantages. For example, since multiple controllers are used to sense touches near a boundary between the quadrants, the sensitivity of the touch sensor at the boundaries may be improved by reducing discontinuities that are present when the electrodes at the boundaries are not interlaced with each other. Further, in this configuration, all of the electrodes near the boundaries are full size (i.e., a full diamond as opposed to a half diamond), which has the effect of increasing the touch sensitivity of the touch sensor assembly 100 near the boundaries by permitting the capacitance near the boundary electrodes to be the same as the capacitance of the other, non-boundary electrodes.

Each of the controllers 70a-d may be coupled to a processor (CPU) that is included as part of the associated electronic device (e.g., the ATM 30 shown in FIGS. 2 and 3). The processor may be operable to execute software that functions to resolve the location on the touch sensor that has been touched by a user. In this regard, the processor may receive input from one or more of the controllers 70a-d, and resolve the position of a user's touch based on the input received. Further, the processor may be operable to execute software that receives touch input from a user and performs one or more functions. For example, the software may includes software to run an ATM, software to run a voting machine, software to run a casino game, or the like.

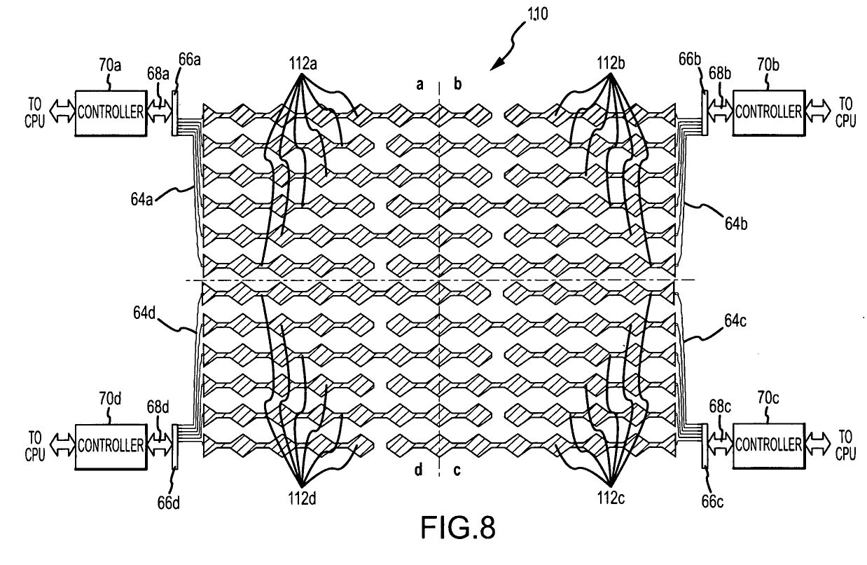

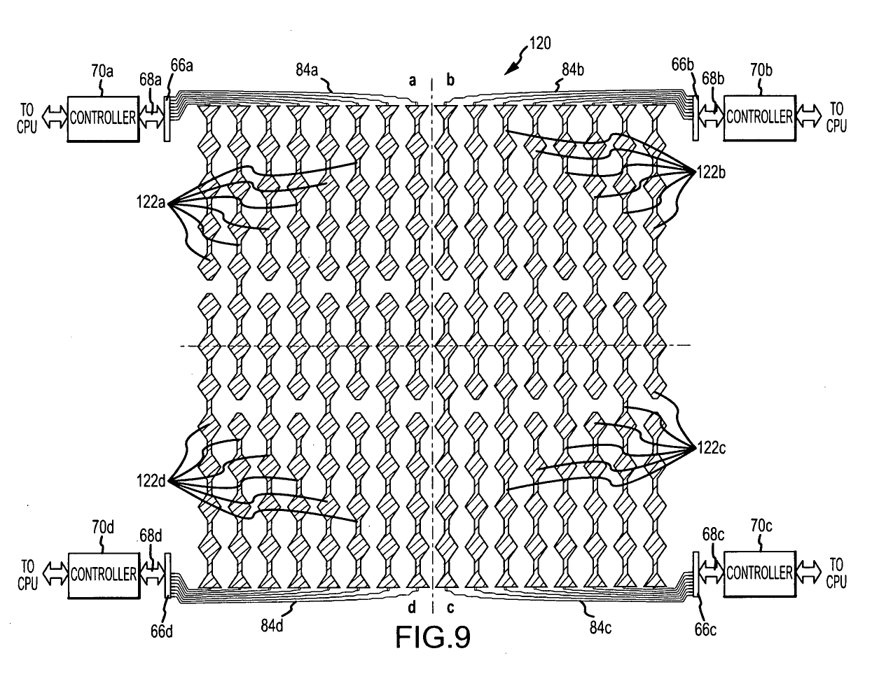

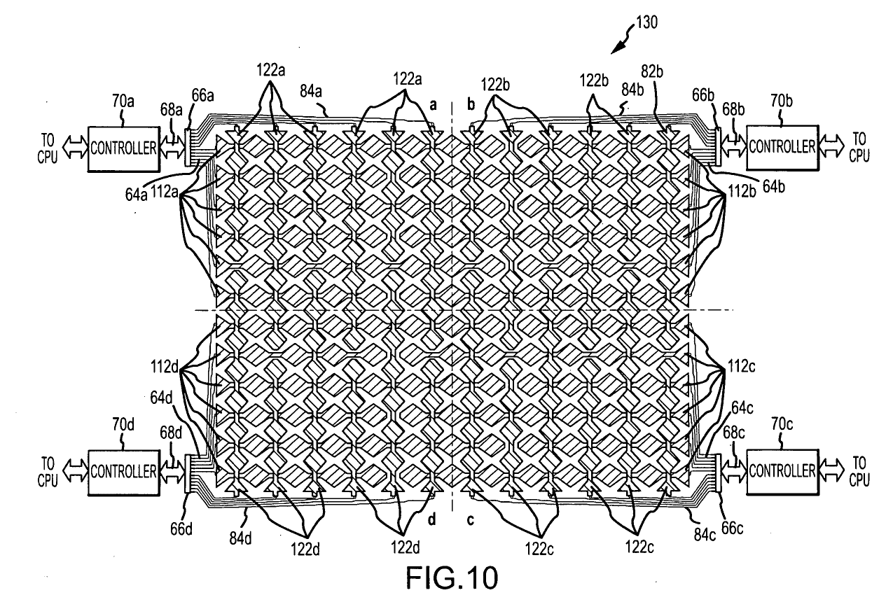

FIGS. 8-10 illustrate a bottom conductive layer 110 (shown in FIG. 8), a top conductive layer 120 (shown in FIG. 9), and the combined assembly 130 of the top and bottom layers (FIG. 10) for another exemplary touch sensor assembly. In FIGS. 8-10, elements that are similar or identical to elements shown in FIGS. 5-7 are identified with like reference numerals.

FIG. 8 illustrates the bottom conductive layer 110, which includes four sets of rows 112a-d of electrodes that are coupled to the respective controllers 70a-d through the metal traces 64a-d. As shown, the arrays of rows 112a-d include diamond-shaped electrodes that are coupled together by relatively thin strips of the conductive material. In this embodiment, each array includes a plurality rows of a longer length (i.e., six full size diamond-shaped electrodes) and a plurality of rows of a shorter length (i.e., four full size diamond-shaped electrodes), wherein a pattern is formed of alternating shorter length rows and longer length rows. In this regard the rows 112a and 112d are in a “zipper” like relationship with the rows 112b and 112c. This configuration may permit the assembly 130 to have an improved touch resolution by reducing the discontinuities along transition regions where electrodes are coupled to different controllers 70a-d.

FIG. 9 illustrates the top layer 120 of conductive material (e.g., ITO) for the touch sensory assembly 130 (shown in FIG. 10). The top layer 120 is similar to the bottom layer 110 shown in FIG. 8 in most respects, except that the strips of conductive material are patterned into four arrays of columns 122a-d that are positioned in the four quadrants a, b, c, d. As shown, the arrays 122a-d include longer columns that have two more electrodes than shorter columns, such that the electrodes next to the electrodes at the ends of the longer columns are bisected by the horizontal dashed line that separates the top half of the touch sensor assembly 130 from the bottom half.

FIG. 10 illustrates the touch screen assembly 130, which includes the top conductive layer 120 and the bottom conductive layer 110. As shown, the pattern formed by the layers 120 and 130 is such that a touch near one of the dashed lines that separates the assembly 130 in to the quadrants a-d will be sensed by multiple controllers 70a-d. In this regard, the touch resolution may be improved by reducing errors due to discontinuities near the edges of the four quadrants a-d. That is, the transition between the quadrants a-d is relatively smooth.

It should be appreciated that the touch screen assemblies 100 and 130 illustrate two embodiments, but that numerous other configurations may be used. For example, the ratio of length of the longer rows/columns relative to the length of the shorter rows/columns may be any suitable value. Further, the lengths of the rows/columns may be varied to form any suitable pattern. For example, the assembly 100 shown in FIGS. 5-7 provides that all of the row/columns associated with a particular controller have the same length. However, the assembly 130 shown in FIGS. 8-10 has alternating longer and shorter rows/columns. Another example would be to include a pattern of alternating sets of two longer rows/columns and two shorter rows/columns. Those skilled in the art should readily recognize that numerous other possible arrangements may be used.

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the invention are desired to be protected.

What is claimed:

1. A touch panel assembly comprising:
a top conductive film that is patterned to form at least two top arrays that each include a plurality of sets of electrodes, wherein the electrodes in each set of electrodes are coupled together by the top conductive film, and wherein each set of electrodes has a first end and a second end, the first end being positioned near an edge of touch panel assembly and the second end being positioned away from the edge, and wherein the second end of each set of electrodes in each top array is disposed adjacent to the second end of a set of electrodes from a different top array;
a bottom conductive film that is patterned to form at least two bottom arrays that each include a plurality of sets of electrodes, wherein the electrodes in each set of electrodes are coupled together by the bottom conductive film, and wherein each set of electrodes has a first end and a second end, the first end being positioned near an edge of the touch panel assembly and the second end being positioned away from the edge, and wherein the second end of each set of electrodes in each bottom array is disposed adjacent to the second end of a set of electrodes from a different bottom array; and
an insulating layer disposed between the top conductive film and the bottom conductive film;
wherein the electrodes at the second end of each of the sets of electrodes have substantially the same area as the electrodes that are adjacent to the electrodes at the second end of each of the sets.

2. The touch panel assembly of claim 1, wherein the top conductive film and the bottom conductive film include indium tin oxide (ITO).

3. The touch panel assembly of claim 1, wherein the top conductive film and the bottom conductive film each include four arrays.

4. The touch panel assembly of claim 1, wherein the first ends of the sets of electrodes in the top arrays are each located near one of a first pair of opposite edges of the touch panel assembly, and wherein the first ends of the sets of electrodes in the bottom arrays are each located near one of a second pair of opposite edges of the touch panel assembly, wherein the first pair of opposite edges and the second pair of opposite edges are different.

6. The touch panel assembly of claim 1, wherein the length of each of the sets of electrodes in one top array is different than the length of each of the sets of electrodes in another top array, and wherein the length of each of the sets of electrodes in one bottom array is different than the length of each of the sets of electrodes in another bottom array.

7. The touch panel assembly of claim 1, wherein the electrodes are substantially diamond-shaped.

8. The touch panel assembly of claim 1, wherein at least a portion of each top array is unaligned with at least a portion of each bottom array.

9. The touch panel assembly of claim 1, further comprising:
a top transparent substrate disposed adjacent to the top conductive film; and
a bottom transparent substrate disposed adjacent to the bottom conductive film;
wherein the top transparent substrate and the bottom transparent substrate include one of plastic or glass.

10. The touch panel assembly of claim 1, wherein the insulating layer includes an optically clear adhesive.

11. An electronic device, comprising:
a display;
a touch panel assembly overlaying the display, the touch panel assembly comprising:
a top transparent substrate that is coated with a top conductive film on its lower surface, the top conductive film being patterned to form at least two top arrays that each include a plurality of sets of electrodes, wherein the electrodes in each set of electrodes are coupled together by the top conductive film, and wherein each set of electrodes has a first end and a second end, the first end being positioned near an edge of the top transparent substrate and the second end being positioned away from the edge, and wherein the second end of each set of electrodes in each top array is disposed adjacent to the second end of a set of electrodes from a different top array;
a bottom transparent substrate that is coated with a bottom conductive film on its upper surface, the bottom conductive film being patterned to form at least two bottom arrays that each include a plurality of sets of electrodes, wherein the electrodes in each set of electrodes are coupled together by the bottom conductive film, and wherein each set of electrodes has a first end and a second end, the first end being positioned near an edge of the bottom transparent substrate and the second end being positioned away from the edge, and wherein the second end of each set of electrodes in each bottom array is disposed adjacent to the second end of a set of electrodes from a different bottom array; and
an insulating layer disposed between the top transparent substrate and the bottom transparent substrate;
wherein the electrodes at the second end of each of the sets of electrodes have substantially the same area as the electrodes that are adjacent to the electrodes at the second end of each of the sets; and
at least one controller that is coupled to the first end of each set of electrodes, the at least one controller being operable to provide electrical signals to the electrodes.

12. The electronic device of claim 11, wherein each top array is substantially but not completely aligned with an associated bottom array to form an array pair, and wherein a separate controller is provided for each array pair.

13. The electronic device of claim 11, wherein the top conductive film and the bottom conductive film include indium tin oxide (ITO).

14. The electronic device of claim 11, wherein the top conductive film and the bottom conductive film each include four arrays.

15. The electronic device of claim 11, wherein the length of each of the sets of electrodes of one top array is different than the length of each of the sets of electrodes of another top array, and wherein the length of each of the sets of electrodes of one bottom array is different than the length of each of the sets of electrodes of another bottom array.

16. The electronic device of claim 11, wherein the electrodes are substantially diamond-shaped.

17. The electronic device of claim 11, wherein a least a portion of each top array is unaligned with at least a portion of each bottom array.

18. The electronic device of claim 11, wherein the top transparent substrate and the bottom transparent substrate include one of plastic or glass.

19. The electronic device of claim 11, wherein the insulating layer includes an optically clear adhesive.

20. A touch panel assembly, comprising:
a top transparent substrate that includes a patterned top conductive layer, the top patterned conductive layer including a first set of electrodes that are electrically stimulated by a first controller and a second set of electrodes that are electrically stimulated by a second controller, wherein a first boundary is formed between the first set of electrodes and the second set of electrodes, and wherein the electrodes adjacent to the first boundary are substantially diamond-shaped;
a bottom transparent substrate that includes a patterned bottom conductive layer, the bottom patterned conductive layer including a third set of electrodes that are electrically stimulated by the first controller and a fourth set of electrodes that are electrically stimulated by the second controller, wherein a second boundary is formed between the third set of electrodes and the fourth set of electrodes, and wherein the electrodes adjacent to the second boundary are substantially diamond-shaped; and
an insulating layer disposed between the top transparent substrate and the bottom transparent substrate;
wherein at least portions of the first boundary and the second boundary are not aligned with each other.

21. A touch panel assembly, comprising:
a first patterned conductive layer including a plurality of regions that each include one or more substantially parallel elongated electrodes, the one or more elongated electrodes in one or more regions having a greater length than the one or more elongated electrodes in one or more other regions, the boundaries between the regions being defined by boundary lines, wherein the boundary lines in the layer are either substantially parallel to or substantially orthogonal to each other, wherein for at least one of two orthogonal directions across the layer the boundary lines are parallel but not collinear;
a second patterned conductive layer including a plurality of regions that each include one or more substantially parallel elongated electrodes, the one or more elongated electrodes in one or more regions having a greater length than the one or more elongated electrodes in one or more other regions, the boundaries between the regions being defined by boundary lines, wherein the boundary lines in the layer are either substantially parallel to or substantially orthogonal to each other, wherein for at least one of two orthogonal directions across the layer the boundary lines are parallel but not collinear; and
an insulating layer disposed between the first and second patterned conductive layers;
wherein there are non-collinear boundary lines in one of the first and second patterned conductive layers that are substantially orthogonal to and in a separate substantially parallel plane from non-collinear boundary lines in the other of the first and second patterned conductive layers.
